(19) United States
(12) Patent Application Publication
(10) Pub. No.: US 2006/0238369 A1
(43) Pub. Date: Oct. 26, 2006

(54) Programming system for remote control devices and method for operating said system

(76) Inventor: Viktor Alexandrovich Mamontov, Vladivostok (RU)

Correspondence Address: Andrey Ermolinsky, PO Box 35-94, Vladivostok, 690035, RU

(21) Appl. No.: 10/555,110

(22) PCT Filed: Apr. 28, 2004
(86) PCT No.: PCT/RU04/00169

§ 371 Date: Nov. 1, 2005

(30) Foreign Application Priority Data
May 5, 2003 (RU) 2003113410

(51) Int. Cl. G05B 19/02; G06F 13/10

(52) U.S. Cl. 340/825.22; 340/825.69

(57) ABSTRACT

The invention relates to a programming system for remote control devices (6) and a method for operating said system consisting in preparing and storing command code data and/or a command transmission protocol for controlling a remote electronic device on an information medium which is used for introducing said data into a device memory unit (6). The novelty of said invention lies in that the information medium is embodied in the form of the memory device of a telecommunication network server which is used for forming and storing database for different remotely controlled electronic equipments. The required data is obtainable from the memory device of said server (1) through the telecommunication network to a remote programmer (3) from which said data is introduces into the memory unit of the device (6), for example with the aid of a cable connection (4). The database can be created from a remote computer (2) through Internet network. Said invention makes it possible to increase a program generality since the server memory can simultaneously store data for controlling completely different electronic equipments in the form of different formats which are used by different producers and to reduce cost and simplify the structural design of reprogrammable general-purposed devices (6).

### TECHNICAL FIELD

The invention relates to the field of electronics and in particular it relates to the programming systems and methods of programming remote control devices. The invention is also relevant to the methods of specific data transmission with net system use.

### BACKGROUND ART

Remote control devices for managing the variety of electronic equipment (TV-sets, video-audio-players and recorders etc) that usually contain a control command relay, a screen for display menu settings, means of switching and putting positions in menu, a transmitter [for example, patents: U.S. Pat. No. 4,712,105, publ. Dec. 8, 1987; U.S. Pat. No. 5,450,079, publ. Sep. 12, 1995; U.S. Pat. No. 5,631,652, publ. May 20, 1997] are well-known. Certain devices are restricted by the use of the fixed set of commands and/or command transmission protocol for the definite electronic devices of the definite producers.

It is known that a common keyboard of a personal computer can be used as a remote control device, and the personal computer itself transforms a signal received from such keyboard into control commands and by means of the wireless transmitter feeds these commands to a remote controlled device [patent U.S. Pat. No. 5,903,259, publ. May 11, 1999]. Such certain technical decision requires high skill of a user for programming when another remote controlled device is added to the system.

It is known a remote control device for controlling a variety of different electronic equipment that have the possibility of reprogramming owing to the possibility of receiving, storing and performing commands codes from any other remote control devices with infra-red transmitter [patent U.S. Pat. No. 4,626,848, publ. Dec. 2, 1986]. The device comprises an infra-red receiver, a microprocessor, a memory unit, an infra-red transmitter. However a user can not always find a necessary remote control device for reprogramming.

It is known a method for remote control for programming universal devices of remote control chosen as a prototype [patent RU 2182349, publ. May 10, 2002]. The method is implemented by means of a separate information medium designed for storage the data of the commands code and/or the command transmission protocol for remote control a remotely controlled electronic equipment. A remote control device for different remotely controlled equipment includes a user's activity receiving unit, a commands transmission unit, adata code input unit (the code is stored on the information medium), a data code memory unit, a microprocessor. The used information medium in the form of a bar-code is not universal, and an agreement between various producers in respect of the usage of the common standard of such bar-code is required. A scanner used in the device for reading the bar-code complicates such device, enlarges its dimensions and increases its costs.

### DISCLOSURE OF THE INVENTION

The technical problem to be solved is to extend the universality of programming, simplification and decreasing of the cost of programmable universal (common) remote control devices.

Here and further through the text the term “programming” has to be understood also as reprogramming; the given term is known also as “learn” from the prior art; in this case the term “learning” is used in respect of a remote control device.

The inventive programming system for remote control devices comprises an information medium designed for storage of command code data and/or a command transmission protocol for controlling by a remote control device; the remote control device for controlling different remotely controlled electronic equipments, which includes a user's activity receiving unit, a command transmission unit, an input unit for input of the data of the code and/or the protocol stored on the information medium, a memory unit for the data of the code and/or the protocol, a microprocessor. The novelty of said invention lies in that the information medium is embodied in a form of a memory device placed on a telecommunication network server and designed for the storage of the data of the code and/or the protocol for controlling of various remote controlled electronic equipments; and the system further comprises a remote programmer provided with a connection device for connection to the telecommunication network and a transmission device for transmission the data of the code and/or the protocol received by the remote programmer from the information medium via the telecommunication network to the input unit of the remote control device.

A personal computer can be used as the remote programmer.

The Internet can be used as the telecommunication network best of all.

The personal computer can have a possibility of visual representation of the received data of the code and/or the protocol in a form of set of digits and/or characters, and the input unit of the remote control device can have a possibility of a manual input the set of digits and/or characters into the memory unit of the remote control device. In this case, the input unit can be combined with the user's activity receiving unit of the remote control device.

The transmission device of the remote programmer can be made as a wave transmitter of radio-, infra-red- or supersonic band of waves and includes a corresponding coder/decoder; and the input unit of the remote control device can be made as a wave receiver of radio- or infra-red band of waves and includes a corresponding coder/decoder. It is possible to use the transmitter and the receiver that employ electromagnetic waves of another bands for the data transmission.

Also a cable connection can be used as the transmission device of the remote programmer, in this case both the remote programmer and the remote control device have to be supplied with ports for the cable connection (RS-232, USB and so on). Common cable circuits are also possible, for example, wire telegraph connection.

The inventive method for programming system for remote control devices comprises following steps: command codes data and/or a command transmission protocols for controlling different remotely controlled electronic equipments are collected and stored on an information medium, the data of the command codes and/or the protocols are input into a memory unit of a remote control device from the information medium. The innovation is that the information medium is used in a form of a memory device placed on a telecommunication network server in which a data base of the codes and/or the protocols are created and stored, and required data of the codes and/or the protocols are received from the memory device of the telecommunication network server via the telecommunication network to a remote programmer from which the required data are input in a memory unit of the remote control device. Thus the universality of programming is enlarging, because it can be stored in the server's memory simultaneously information about data for control of absolutely different electronic equipments in various formats used by different electronic equipment producers, and also such data can be easily obtained for programming of a separate remote control device equipped with a memory unit and a data input unit for data input from the programmer, for example, an universal one.

A computer can be used as the remote programmer best of all, precisely a personal one which is equipped with peripheral devices, universal output devices that can be used for the data transmission into the memory unit of the remote control device.

The data base of the code and/or the protocols can be created via telecommunication network from a remote computer.

Before receiving the required data it can be possible to search the required data of the codes and/or protocols within the memory device of the telecommunication network server via this telecommunication network from a remote computer.

When the remote programmer has received the required data of the code and/or the protocol, such data can be input in the memory unit of the remote control device by means of wire and wireless connection. For this purpose any common or special wave transceivers of either radio-, infra-red or supersonic band (or other electromagnetic waves) together with corresponding coder/decoder can be used, and also cable (wire) connection can be used; in this case both the remote computer and the remote control device have to have universal ports for cable connection (R-232, USB and so on).

Also when the remote programmer has received the required data of the code and/or the protocol, such data can be represented visually in the form of set of digits and/or characters on a corresponding peripheral device of the remote programmer, for example, on a monitor screen or on a printer; after that the set of digits and/or characters is visually read and manually input into the memory unit of the remote control device by means of a user's activity receiving unit of the remote control device.

### BRIEF DESCRIPTION OF THE FIGURES ON THE DRAWINGS

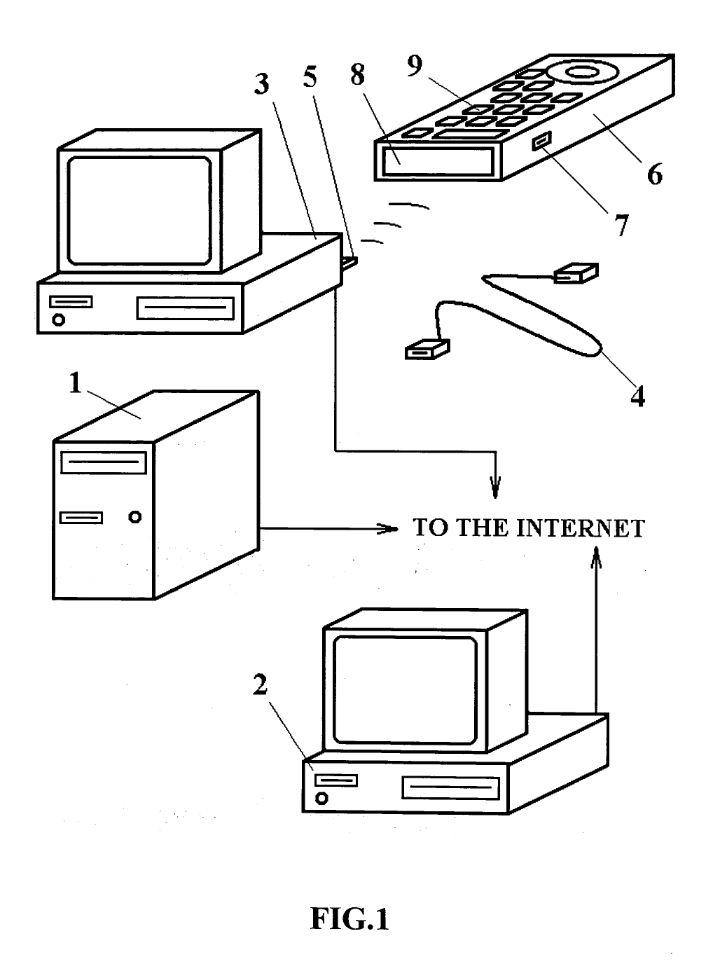

To clarify the invention a schematic drawing of a system for learning remote control devices is shown on FIG. 1.

The remote control device (6) and cable with USB-connectors (4) are shown in enlarged scale comparing with other elements of the drawing.

### THE EXAMPLE FOR CARRYING OUT THE INVENTION

The invention is illustrated by the example of the system for learning (so that programming or reprogramming) of universal remote control devices for different remotely managed electronic equipment, for example for household appliance (TV-sets, video- and audio-players and recorders, machine tools having digital programmed controls and so on).

The system comprises: a server 1 of the Internet on a base of a standard platform, for example “Windows NT” or “Linux” having a memory device of which data of codes and/or protocols of command transmission designed for remote control of different remotely controlled electronic equipment of different producers, are stored; personal computers 2 of producers of the remotely controlled electronic equipment connected with the Internet; personal computers 3 of users, also connected with the Internet and supplied with peripheral devices, for example, monitors and/or printers, output devices, for example, USB ports (not shown) for cable 4 connection and/or a wave transmitter 5 of infra-red (or other) band together with corresponding coder/decoder; an universal (common) remote control device 6 equipped, for example, with USB ports 7 for cable 4 connection and wave transceiver 8 of infra-red (or other) band together with corresponding coder/decoder. In the construction of the remote control device 6 there are also composites, usual for such analog devices—a user's activity receiving unit 9; a code data memory unit that has a function of writing of additional information, or re-writing of the present one; a microprocessor and so on (not shown). The corresponding software of the server 1 and in case of need of personal computers 3 that realizes the method, is not a subject of the protection within the scope of the invention.

The system operates in the following manner. A producer of remotely controlled electronic equipment inputs into a memory device the server 1 data of the command code and protocol of the command transmission designed for a remote control of a definite model of some electronic equipment, for example, by using the code and protocol transmission from his own computer 2 via the Internet. Other producers act analogically and, as a result, data base of the command codes and protocols of the command transmission of various models of the remotely controlled electronic equipments of different producers are created on the memory device of the server 1. There is no doubt that such base can be prototyped (created) without the usage of the Internet when the data are placed, for example, by means of magnetic information medium. The user when he needs to use the remote control device 6 for a new model of a electronic equipment, from the computer 3 connects via Internet with server (1), selects in the data base the command code and the protocols of the command transmission of this model of the equipment and after finding them the user receives them into the memory device of his own computer 3 [RAM, hard disc, floppy disc and so on]. Further, the user trains (programs) the remote control device 6 with new commands by the data transmitting into the memory device of the remote control device by means of the transmitter 5 and the receiver 8 or by means of the cable 4 and ports 7. The variant is possible when the code is visually echoed on one of the peripheral output devices of the computer 3, for example, on the monitor screen and/or it is printed by means of the printer in the form of the terminal digital and/or character set placed in definite order; after that the user visually read such code and put it into the memory device of the remote control device 6 manually by means of the unit 9, for example, by the set of the corresponding succession of digits and characters by means of mechanical or sensor buttons of the unit 9. Then the user has a possibility to control remotely the new model of electronic equipment by means of unit 9 transmitting the commands by using the transmitter 8.

The presented example is used only for the purposes to illustrate one of embodiments of the present invention and is not to be taken by way of limitation. The scope of the present invention are to be limited only by the claims. Thus an expert in this technical field is able to carry out other embodiments of the present invention in rather simple manner.

1. A programming system for remote control devices comprising an information medium designed for storage of command code data and/or a command transmission protocol for controlling by a remote control device; the remote control device for controlling different remotely controlled electronic equipments, which includes a user's activity receiving unit, a command transmission unit, an input unit for input of the data of the code and/or the protocol stored on the information medium, a memory unit for the data of the code and/or the protocol, a microprocessor, which differs in that the information medium is embodied in a form of a memory device placed on a telecommunication network server and designed for the storage of the data of the code and/or the protocol for controlling of various remote controlled electronic equipments; the system further comprises a remote programmer provided with a connection device for connection to the telecommunication network and a transmission device for transmission the data of the code and/or the protocol received by the remote programmer from the information medium via the telecommunication network to the input unit of the remote control device.

2. The system of claim 1, wherein a personal computer is used as the remote programmer.

3. The system of claim 1, wherein the Internet is used as the telecommunication network.

4. The system of claim 2, wherein the personal computer has a possibility of visual representation of the received data of the code and/or the protocol in a form of set of digits and/or characters, and the input unit of the remote control device has a possibility of a manual input the set of digits and/or characters into the memory unit of the remote control device.

5. The system of claim 4, wherein the input unit is combined with the user's activity receiving unit of the remote control device.

6. The system of any claim 1-3, wherein the transmission device of the remote programmer is made as a wave transmitter of radio-, infra-red- or supersonic band of waves and includes a corresponding coder/decoder; and the input unit of the remote control device is made as a wave receiver of radio- or infra-red band of waves and includes a corresponding coder/decoder.

7. The system of any claim 1-3, wherein a cable connection is used as the transmission device of the remote programmer, and both the remote programmer and the remote control device are supplied with ports for the cable connection.

8. A method for programming system for remote control devices comprising following steps: command codes data and/or a command transmission protocols for controlling different remotely controlled electronic equipments are collected and stored on an information medium, the data of the command codes and/or the protocols are input into a memory unit of a remote control device from the information medium, which differs in that that the information medium is used in a form of a memory device placed on a telecommunication network server in which a data base of the codes and/or the protocols are created and stored, and required data of the codes and/or the protocols are received from the memory device of the telecommunication network server via the telecommunication network to a remote programmer from which the required data are input in a memory unit of the remote control device.

9. The method of claim 8, wherein a computer is used as the remote programmer.

10. The method of claim 8, wherein the data base of the codes and/or the protocols are created via the telecommunication network from a remote computer.

11. The method of claim 8, wherein a search of the required data of the codes and/or protocols is carry out within the memory device of the telecommunication network server via the telecommunication network from a remote computer before receiving the required data.

12. The method of claim 8, wherein the required data received to the remote programmer are put in the memory unit of the remote control device by means of wire or wireless communication.

13. The method of claim 8, wherein the required data received to the remote programmer are visually represented in the form of set of digits and/or characters on a corresponding peripheral device of the remote programmer; and the set of digits and/or characters is visually read and then manually input into the memory unit of the remote control device by means of a user's activity receiving unit of the remote control device.
